(19) United States
(12) Patent Application Publication
(10) Pub. No.: US 2015/0293994 A1
(43) Pub. Date: Oct. 15, 2015

(54) ENHANCED GRAPH TRAVERSAL

(71) Applicant: HEWLETT-PACKARD DEVELOPMENT COMPANY, L.P., Houston, TX (US)

(72) Inventor: Terence P. Kelly, Palo Alto, CA (US)

(21) Appl. No.: 14/439,206

(22) PCT Filed: Nov. 6, 2012
(86) PCT No.: PCT/US2012/063676

§ 371 Date: Apr. 28, 2015

(51) Int. Cl. G06F 17/30

(52) U.S. Cl. CPC G06F 17/30705; G06F 17/30719

(57) ABSTRACT

In one implementation, graph traversal method identifies a quantity of nodes within a graph, traverses a portion of the graph, and aborts traversal of the graph in response to a determination that a node-access counter satisfies a condition relative to the quantity of nodes within the graph. At least one edge of the graph is not considered during traversal of the graph.

### BACKGROUND

Graphs are often used to represent relationships among various entities. For example, nodes of a graph can represent communications entities such as wireless communications devices, and edges of the graph can describe connections among the wireless communications devices for nodes). As a specific example, a graph can be constructed within a memory of a computing system to describe connections among wireless communications devices within a mesh network. As another example, a graph can represent a social network such that the nodes of the graph represent profiles of users within the social network and the edges of the graph represent connections or relationships among the users of the social network. As yet another example, a graph can represent relationships such as spatial or placement relationships among genes on a chromosome.

A graph is traversed to identify properties of and/or relationships between the entities represented by the nodes in the graph. Traversing a graph typically includes identifying edges connecting one node of the graph to other nodes, and following those edges to access the nodes in the graph. The graph traversal continues iteratively or recursively until a node with a particular property (or with particular properties) is identified or all the edges of the graph have been followed. Other graph traversals include operations to classify nodes, and continue until all nodes of the graph have been classified.

### BRIEF DESCRIPTION OF THE DRAWINGS

FIG. 1 is a flowchart of an enhanced graph traversal, according to an implementation.

FIG. 2 is an illustration of a graph, according to an implementation.

FIG. 3 is an illustration of an environment represented by the graph illustrated in FIG. 2, according to an implementation.

FIGS. 4A-4H illustrate an enhanced graph traversal of a graph, according to an implementation.

FIG. 5 is a schematic block diagram of a computing system hosting a graph and a graph traversal module, according to an implementation.

FIG. 6 is a flowchart of an enhanced graph traversal, according to another implementation.

### DETAILED DESCRIPTION

Because traversal of a graph often proceeds until all the edges of the graph have been considered (i.e., followed from one node to another node), graph traversals often unnecessarily consider edges. That is, some graph traversals that typically terminate after the edges of the graph are exhaustively considered rather than in response to identification of a node with a particular property (or with particular properties) can be aborted (i.e., terminated or stopped) before all the edges of the graph are considered without altering the results such graph traversals. Unnecessarily considering edges during graph traversal does not change the results or output of the graph traversal, but can lead to worse performance, depending on the specifics (e.g., in what arrangements or topologies edges connect nodes) of the graph that is traversed.

Implementations of enhanced graph traversals discussed herein track the number of nodes in a graph (also referred to as vertices) accessed during a traversal of the graph. Additionally, such implementations determine whether the number of nodes accessed during traversal of the graph satisfies a condition relative to the quantity of nodes within the graph. As examples, the condition can be an equality condition (i.e., the condition determines whether the number of nodes accessed during traversal of the graph is equal to the quantity of nodes in the graph) or a percentage condition (i.e., the condition determines whether the number of nodes accessed during traversal of the graph is equal to a predetermined percentage of the quantity of nodes in the graph).

In such implementations, traversal of a graph is aborted when the number of nodes accessed during the traversal satisfies the condition relative to the quantity of nodes within the graph. Aborting the graph traversal in response to a determination that the number of nodes accessed during traversal of the graph satisfies the condition relative to the quantity of nodes within the graph can improve performance of the graph traversal because edges of the graph are not unnecessarily considered. In other words, implementations discussed herein can improve performance of graph traversals by aborting such graph traversals after a sufficient number of nodes have been accessed to cause additional consideration of edges or accesses to nodes to be unnecessary (e.g., not alter or improve the result or output of the graph traversal).

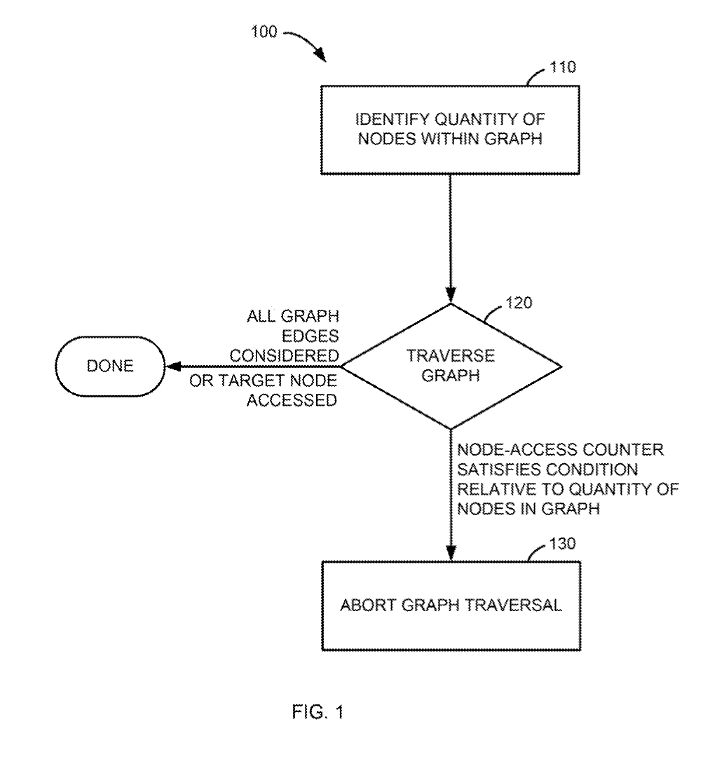

FIG. 1 is a flowchart of an enhanced graph traversal, according to an implementation. Enhanced graph traversal 100 illustrated at FIG. 1 can be implemented at, for example, a graph analysis module hosted at a computing system. A quantity of nodes within a graph is identified at block 110. A graph is a collection of nodes that are related one to another. In some implementations, each node within a graph includes references such as memory addresses of, pointers to, or unique identifiers of nodes within the graph that are related or connected to that node. In other implementations, the relationships among the nodes of a graph defined in other ways. For example, the relationships among the nodes of a graph can be implicit in the storage locations (e.g., memory locations) at which nodes are stored or can be defined in metadata (e.g., a map or description) of the graph.

Edges of a graph define the relationships between nodes of the graph, and can be represented using a variety of methodologies. In some implementations, an edge can be referred to as an arc or link. As an example, nodes within an undirected graph can be referred to as edges or undirected edges, and nodes within a directed graph can be referred to as arcs or directed arcs. As used herein, the term edge refers to edges, arcs, links, or other terms describing mechanisms that define the relationships between nodes of the graph.

As an example of an edge, a reference to a first node that is stored at a second node is an edge between the first node and the second node. As another example, a metadata description of a relationship between a first node and a second node within a graph can be referred to as an edge of the graph. An edge of a graph is considered (or followed) when a node is accessed using that edge. As specific examples, an edge can be considered (or followed) by dereferencing a memory address or pointer to access a node, or by selecting a node from a group of nodes using a unique identifier of that node.

The relationships defined by edges vary based on a variety of characteristics of a graph such as the use of the graph and the entities represented by the nodes of the graph. For example, an edge can indicate that the entities represented by nodes connected by the edge: are accessible (e.g., physically by road, network cables, or wireless technologies or logically via a communications network including intermediate computing systems) one to another; are associated one with another (e.g., the nodes represent users within a social network environment (or social network) and edges connect users who have established a relationship one with another or can represent individuals in an organizational chart); have a hierarchical structure described by the edges; and/or are otherwise related. As a specific example, edges in a graph (e.g., arcs in a directed acyclic graph (DAG)) can encode temporal precedence constraints among tasks or activities. For example, an edge from a node representing a first task to a node representing a second task can indicate or express that the first task must be completed before the second task may commence according to a scheduling policy within a computing system or computing facility.

A node of a graph is a portion (or portions) of memory (e.g., memory locations within a random-access memory (RAM), entries within a database, or files or portions of one or more files within a file system) that represents some entity. For example, a node can be a group of memory locations within memory at which representations of properties or characteristics of an entity (e.g., values representing those properties or characteristics) such as relationships between that entity and other entities are stored. In some implementations, a node includes references to other nodes within a graph that are related to that node. These references can be referred to as edges of the graph.

As a specific example, a node can be a portion of a memory at which a list of edges of that node (or edges adjacent to or incident upon that node) are stored. Moreover, the edges can be represented in any of a variety of formats. For example, the edges can be represented in a compressed format. As a specific example, a graph can be represented as a matrix of binary values. Each column in the matrix represents a node. In other words, each column is a node. The row values of each column indicate whether an edge exists between that node (the node represented by that column) and another node.

More specifically, the matrix can be an N×N matrix, where N is the number of nodes in the graph. Each column represents (or can be said to be a node in the graph, and each row is associated with the node in the graph represented by the column with the same index as the index of that row. In other words, first row is associated with the node represented by the first column, the second row is associated with the node represented by the second column, etc. A value of 0 at a row within a column of the matrix indicates that the node represented by that column does not have a edge connecting it to the node associated with that row. A value of 1 at a row within a column of the matrix indicates that the node represented by that column has a edge connecting it to the node associated with that row. In some implementations, the columns (or column vectors) of the matrix can be compressed. In some implementations, the graph can be represented as a transpose of that matrix such that the rows are nodes and the columns are associated with nodes.

A node is said to be accessed when one or more memory locations at which representations of properties or characteristics of the entity represented by that node are read from or written to. For example, referring to the example above, a node is accessed when a column representing that node in a matrix representing a graph is read. As another example, a node is accessed when output information such as a distance of that node from a source node, information about a set including that node, an identifier of that node, or other output information for that node is written, determined, finalized, or output during a traversal of the graph including that node.

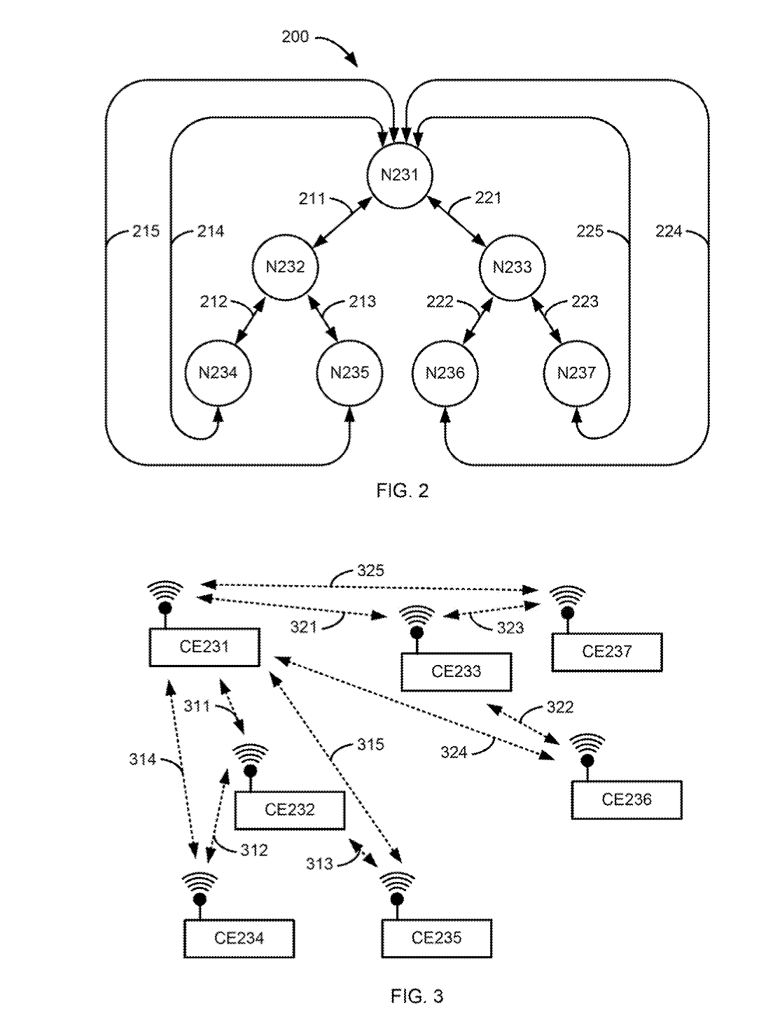

FIG. 2 is an illustration of a graph, according to an implementation. Graph 200 is illustrated graphically in FIG. 2, and includes nodes N231, N232, N233, N234, N235, N236, and N237 and edges 211-215 and 221-225. As discussed above, nodes are portions of memory that represent entities, and edges define relationships between nodes. Accordingly, the representation of graph 200 illustrated in FIG. 2, and other graphical representations of graphs included herein, should be understood as a visualization of a graph rather than a graph as such.

Referring to graph 200: nodes N232 and N233 are related or connected to node N231 by edges 211 and 221, respectively; nodes N234 and N235 are related or connected to node N232 by edges 212 and 213, respectively; nodes N236 and N237 are related or connected to node N233 by edges 222 and 223, respectively; and node N231 is related or connected to nodes N234, N235, N236, and N237 edges 214, 215, 224, and 225, respectively. As illustrated in FIG. 2, edges 211-215 and 221-225 are bidirectional, but in other implementations edges can be non-directional, unidirectional, or a combination of bidirectional, non-directional, and unidirectional. In other words, graph 200 can be referred to as an undirected graph.

As discussed above, nodes of a graph represent entities, and the edges of the graph represent relationships among those entities. FIG. 3 is an illustration of an environment represented by the graph illustrated in FIG. 2, according to an implementation. The environment illustrated in FIG. 3 includes a group of communications entities that communicate one with another via wireless communications channels 311-315 and 321-325. Communications entities CE231, CE232, CE233, CE234, CE235, CE236, and CE237 are represented in FIG. 2 by nodes N231, N232, N233, N234, N235, N236, and N237, respectively. Communications channels 311-315 and 321-325 are represented in FIG. 2 by edges 211-215 and 221-225, respectively.

Communications entities CE231, CE232, CE233, CE234. CE235, CE236, and CE237 can be, for example, computing systems including wireless communications interfaces within a mesh network. In this example, communications entities CE234, CE235, CE236, and CE237 are located at distances from communications entity CE231 that are greater than the distances at which communications entities CE234 and CE235 are located from communications entity CE232 and at which communications entities CE236 and CE237 are located from communications entity CE233. Communications entities CE234, CE235, CE236, and CE237 can communicate with communications entity CE231 directly via communications channels 314, 315, 324, and 325, respectively, in a high-power state (i.e., a high-power transmission state), and can communicate with communications entity CE231 indirectly through communications entities CE232 and CE233 via communications channels 312, 313, 322, and 323, respectively, in a low-power state (i.e., a low-power transmission state). Thus, communications entities CE234, CE235, CE236, and CE237 each have two communications channels through which communications entity CE231 is accessible. Accordingly, graph 200 illustrated in FIG. 2 represents connectivity among communications entities CE231, CE232, CE233, CE234, CE235, CE236, and CE237. Said differently, the relationships among the nodes of graph 200 (i.e., edges 211-215 and 221-225) describe connectivity among communications entities CE231, CE232, CE233, CE234, CE235, CE236, and CE237.

Referring to FIG. 1, a quantity of nodes within a graph can be identified using a variety of methodologies. A graph analysis module can identify a quantity of nodes within a graph at block 110, for example, by performing an exhaustive search of the graph to consider (or follow) each edge within the graph to count each node within the graph. As another example, the quantity of nodes within the graph can be identified by reading a representation of the graph from a processor-readable medium or receiving the representation of the graph via a communications interface.

As yet another example, a graph analysis module can identify a quantity of nodes within a graph by parsing a description of the graph. For example, a graph can be described in a document using a markup language such as the Extensible Markup Language (XML). As a specific example, an XML document can include a graph element that includes node elements. Each node element can include various elements or attributes of the entity represented by that node element, including one or more reference elements (or attributes) identifying other nodes elements within the graph element that are related to that node element. A graph analysis module can parse the XML document (description of the graph) to identify the number of nodes within the graph. In yet other implementations, the quantity of nodes within the graph can be a identified from input to an enhanced graph traversal process (e.g., the quantity of nodes within the graph can be an input to the enhanced graph traversal), or can be metadata related to the graph stored at a processor-readable medium.

In some implementations, identifying the number of nodes within the graph can occur when constructing the graph within a memory. For example, a graph analysis module can parse a description of a graph to construct (or realize or instantiate) the graph based on the description within a memory of a computing system hosting the graph analysis module. To identify the number of nodes within the graph, the graph analysis module can count the number of nodes constructed within the memory.

In some implementations, a graph analysis module identifies the number of nodes within a graph in response to requests to add nodes to a graph. For example, a node counter can be initialized (e.g., to zero or a known initial quantity of nodes within a graph), and the node counter can be incremented each time a request to add a node is received or processed (or handled). A request to add a node can be processed by defining a node within a memory (e.g., allocating or reserving memory locations within the memory for the node), and inserting the node into the graph by adding at least one edge that connects the node to another node within the graph.

As a specific example, a graph can represent a network environment including computing systems that communicate one with another via communications links. Each time a computing system is added to the network environment, a request to add a node can be generated in response to the addition of that computing system, and the node counter can be incremented. Moreover, each time a computing system is removed from the network environment, a request to remove the node representing that computing system can be generated in response to the removal of that computing system, and the node counter can be decremented. Accordingly, in some implementations block 110 can be realized by a persistent, on-going, or continuous operation or set of operations.

At block 120, the graph is traversed. Traversing a graph means accessing the nodes in a graph in a particular manner or sequence by following (or considering) the edges between nodes. In some implementations, traversing a graph (or a graph traversal) includes updating and/or identifying values stored at the nodes (e.g., values that represent parameters of the entities represented by the nodes). As an example, a graph can represent a network environment in which the nodes of the graph represent communications entities of the network environment, and a traversal of the graph can be a connectivity (or connectedness) traversal to determine whether a communications path (represented by an edge or group of edges of the graph) exists from one node to another node or whether communications paths exists among all the nodes of the graph.

In some implementations, a graph traversal can be used for topological sorting. A traversal to implement a topological sort of a graph, such as a directed acyclic graph (DAG), outputs nodes in a linear (total) order that is consistent with the partial order of precedence constraints encoded (or represented) in the DAG. That is, the output of a topological sort can be visualized as an arrangement of the nodes of a graph on a horizontal line such that all directed edges in the graph go from left to right. A topological sort (or traversal to effect such a topological sort) can be implemented by performing, for example, a depth-first search (DFS) on a graph. Such topological sorts can be enhanced by systems and methodologies discussed herein.

As specific examples, a graph such as a directed acyclic graph (DAG) can be used to represent temporal precedence constraints or constraints on location. For example, each node in such a graph can represent a task such as a task to be scheduled within a computing facility (e.g., a datacenter or distributed computing environment). A directed edge from a first node to a second node in such a graph can represent that the task corresponding to the first node should be performed before the task corresponding to second node. In another example, the nodes in such a graph can represent entities (e.g., objects) and the edges of the graph can represent physical relationships among the entities. An edge from a first node to a second node can encode (or represent) that the physical entity represented by the first node is located to the left of the entity represented by the second node, where both the first node and the second node are located on some continuum.

Computational genomics is an example application of topological sorting. Laboratory analyses of the genomes of complex organisms sometimes yield imperfect or incomplete information about the positions of features such as genes on chromosomes. In some genomics implementations, partial order information concerning the relative position of genes is available. Partial order information in such an example can be, for example, that gene 5 lies before gene 6 on chromosome 7. Such information can be encoded within a DAG. For example, the DAG can include a first node representing gene 5, a second node representing gene 6, and a directed edge from the first node to the second node. A topological sort of such a graph outputs a plausible total order of genes on each chromosome. That is, a total order that is consistent with the pairwise constraints encoded by the edges of the graph.

As another example application, systems and methodologies discussed herein can be applied to topological sorting for path planning. Such applications can be useful to enhance efficiency (e.g., processing efficiency) of routing or path selection processes in autonomous and semi-autonomous vehicle systems such as unmanned aerial vehicles (UAVs) and unmanned automobiles. In other words, in such applications, the nodes of the graph can be waypoints along a path, and the edges represent path segments between the waypoints. The graph can be traversed using systems and methodologies discussed herein to identify a particular path such as an optimal path between a pair of waypoints. As yet another example applications, systems and methodologies discussed herein can be applied to topological sorting for data and/or program flow analysis of software applications. For example, topological sorting can be used to analyze software source code to determine program and/or data flows within a software application for optimization and/or security analysis.

Typically, a graph traversal continues until all the edges of the graph are considered to exhaustively search the graph for all the nodes of the graph. Alternatively, some graph traversals terminate when a particular node (e.g., a target node with a particular value) is found or accessed, but will continue until all the edges of the graph are considered to exhaustively search the graph for all the nodes of the graph if that particular node does not exist in the graph. If the graph traversal at block 120 completes or terminates under either of these conditions, enhanced graph traversal 100 is done.

Rather than rely on an exhaustive traversal of the graph by considering all the edges of the graph to determine that all the nodes of the graph have been accessed, enhanced graph traversal 100 uses the quantity of nodes within the graph identified at block 110 to determine when all the nodes of the graph have been accessed. Said differently, the graph traversal is aborted in response to per-node output information reaching a final state. In this example, all per-node output information reaches a final state when each node has been accessed (e.g., has been identified by following an edge).

Said differently, at block 120 the number of distinct nodes accessed within the graph are tracked or counted (e.g., at a node-access counter of a graph analysis module implementing enhanced graph traversal 100). When that number of nodes (e.g., the node-access counter) satisfies a condition relative to the quantity of nodes, the graph traversal is aborted at block 130. For example, the condition can be an equality condition. In other words, the graph traversal can be aborted when the number of distinct nodes accessed is equal to the quantity of nodes. The graph traversal can be said to have been aborted because it is terminated even though not all the edges of the graph have been considered (e.g., some nodes or edges can remain in a queue used to manage the graph traversal). Said differently, the graph traversal can be terminated at block 130 before those, edges have been considered (i.e., aborted at block 130) because all the nodes in the graph have been accessed.

As another example, the condition can be predetermined percentage condition. In other words, the graph traversal can have not yet considered all the edges of the graph (e.g., some nodes or edges can remain in a queue used to manage the graph traversal), and the graph traversal can be aborted at block 130 before those edges have been considered because a predetermined percentage of the nodes in the graph have been accessed. Thus, the graph traversal can be aborted after only a portion of the graph has been traversed. In other words, the graph traversal can be aborted after only a portion of the edges of the graph has been considered.

As an example of a graph traversal that can be aborted based on a predetermined percentage condition, systems and methodologies discussed herein can be applied to determine centrality measures within a social network environment to identify influential or otherwise interesting individuals within the social network environment. More specifically, a breadth-first search (BFS) can be an inner loop of a centrality measure process. Rather than considering all the edges beginning from the source node for each BFS, process 100 can be applied to each BFS.

The predetermined percentage condition can be a percentage of the number of nodes in a graph representing the social network environment or a portion thereof. Specifically, for example, the predetermined percentage condition can be 90% of the number of nodes in the graph. Thus, each BFS is performed until 90% of the nodes are accessed. By performing the BFS repeatedly from or for each of many source nodes (each representing an individual in the social network), a connectedness can be determined by aggregating the outputs of each BFS.

Furthermore such an approach may be useful to identify exceptionally peripheral individuals within the social network environment. For example, an individual who is not found (i.e., the node representing that individual is not accessed) by repeatedly searching until 90% of individuals are found from many different randomly chosen source nodes in the social network environment. Such an individual can be deemed peripheral to the social network environment.

Although enhanced graph traversal 100 has a worst-case asymptotic complexity equivalent to that of traditional graph traversals (i.e., all edges may need to be considered to access all the nodes of some graphs), enhanced graph traversal 100 can have enhanced or improved performance for some graphs. The enhanced or improved performance can arise from aborting the graph traversal in response to the node-access counter satisfying the condition relative to the quantity of nodes in the graph because, for many graph structures (e.g., relationships among nodes), not all edges need be considered to access all the nodes of the graph. By tracking the quantity of nodes in the graph and the number of nodes accessed during a traversal of the graph, enhanced graph traversal 100 can avoid unnecessarily considering edges or accessing nodes of the graph by aborting the graph traversal after the node-access counter satisfies the condition relative to the quantity of nodes in the graph. These features can be particular advantageous for dense graphs with many edges.

Systems implementing such methodologies can process more information using enhanced graph traversals discussed herein than when using traditional graph traversals because on average such enhanced graph traversals reach an end or complete state more quickly by terminating in response to aborting a graph traversal after a node-access counter satisfies a condition relative to the quantity of nodes in a graph. An end or complete state of a graph traversal refers to a state of the graph traversal at which additional consideration of edges or accesses to nodes will not improve or alter the results of the graph traversal. Said differently, an end or complete state refers to a state of a graph traversal at which additional consideration of edges or accesses to nodes is unnecessary to the outcome or result of the graph traversal.

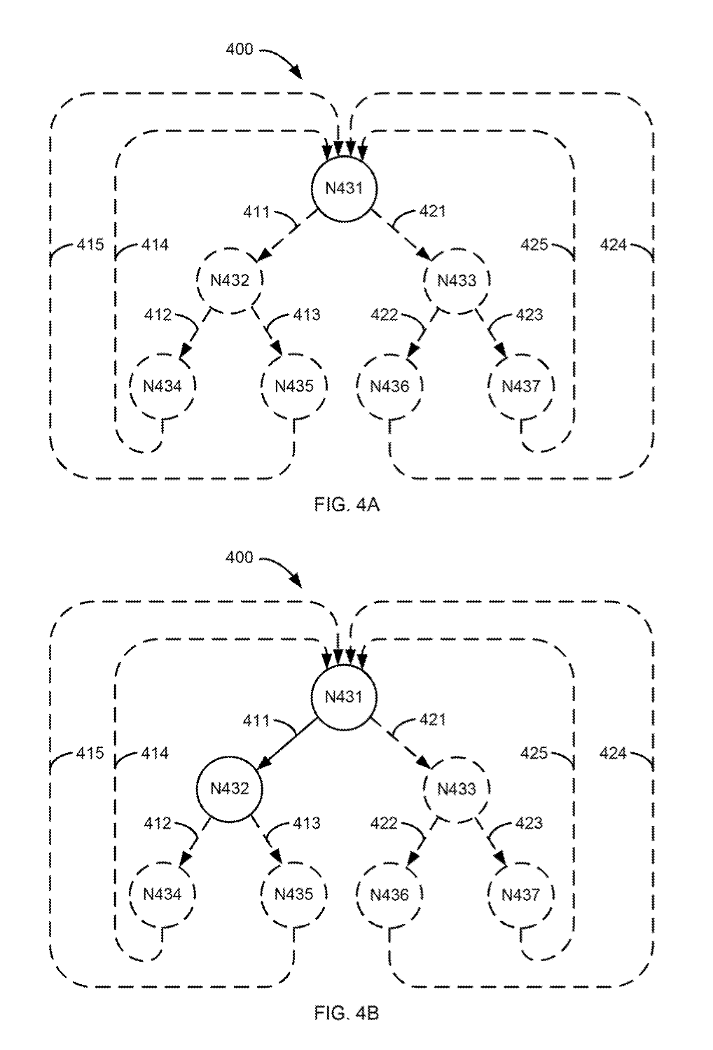

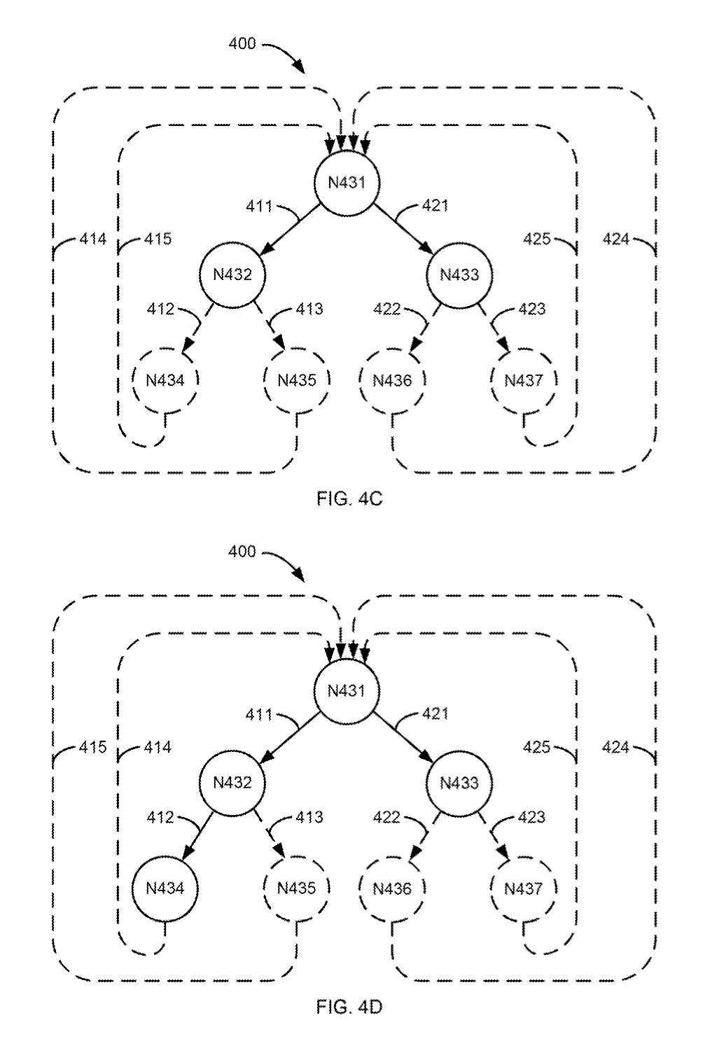

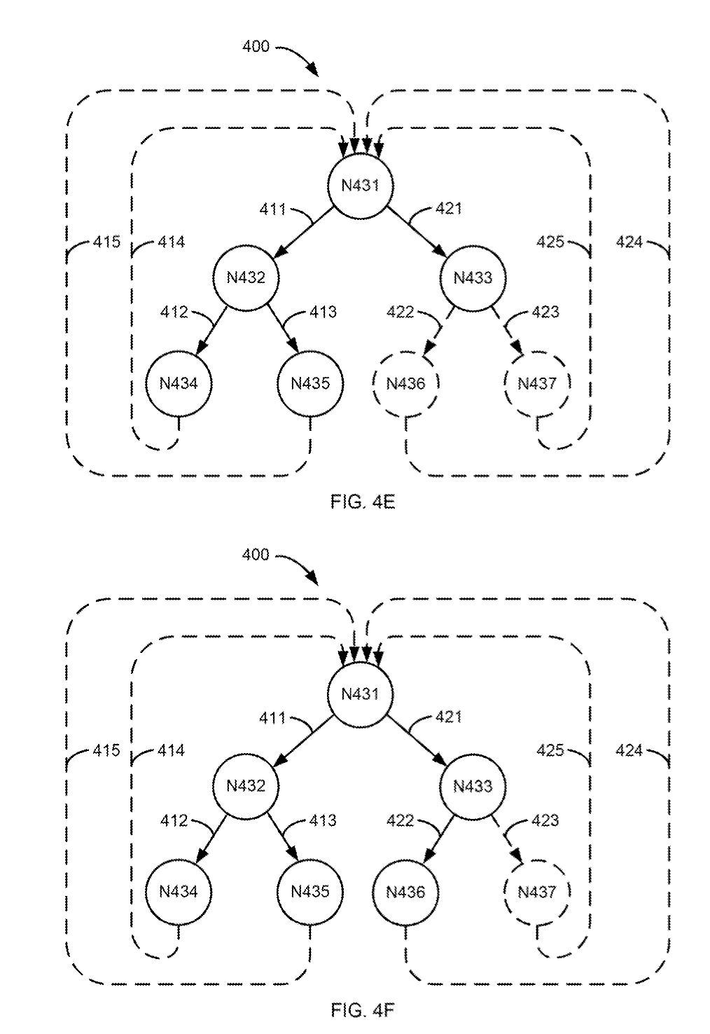

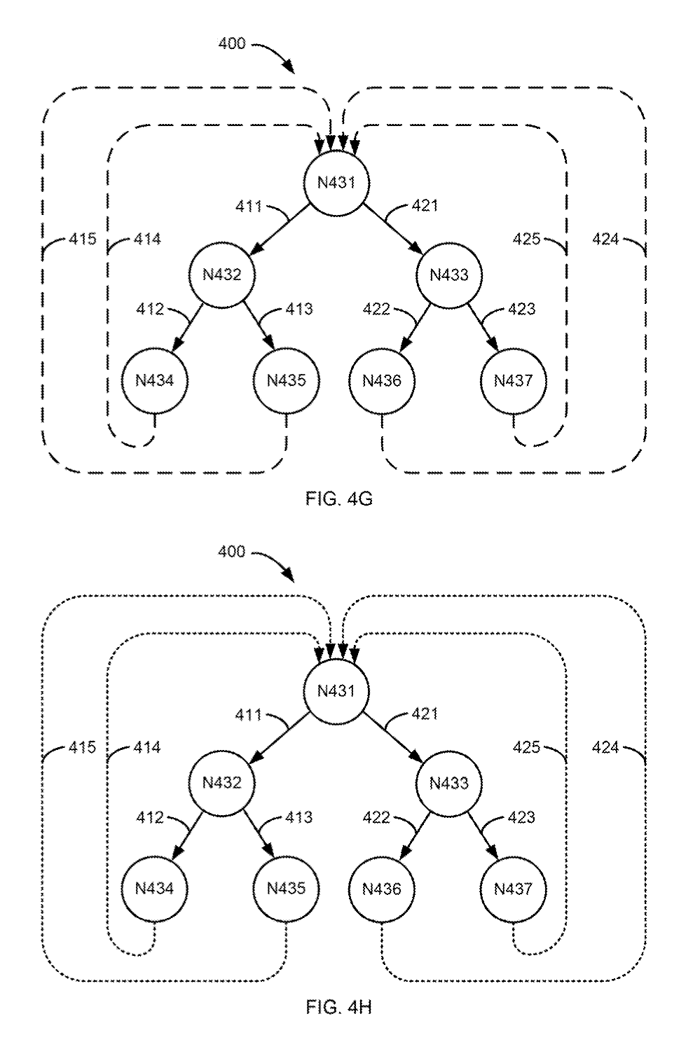

FIGS. 4A-4H illustrate an enhanced graph traversal of a graph, according to an implementation. In contrast to the undirected graph illustrated in FIG. 2, the graph illustrated in FIGS. 4A-4H is a directed graph. Specifically, a breadth-first search or traversal of graph 400 is illustrated in FIGS. 4A-4H. In other implementations, the enhanced graph traversals can be another type of class of graph traversal such as a depth-first search or a partitioning traversal such as a maximal independent set (MIS) partitioning traversal. Graph 400 includes nodes N431, N432, N433, N434, N435, N436, and N437 and edges 411-415 and 421-425. Nodes and edges illustrated in FIGS. 4A-4H with dashed lines have not yet been accessed or considered, respectively, during the enhanced graph traversal. Nodes and edges illustrated in FIGS. 4A-4H with solid lines have been accessed or considered, respectively, during the enhanced graph traversal.

Prior to traversing graph 400, the quantity of nodes in graph 400 is determined to be seven, for example, using one of the methodologies discussed above in relation to FIG. 1. As illustrated in FIG. 4A, node N431 is accessed first. That is, node N431 is the source of the enhanced graph traversal. In response to accessing node N431, a node-access counter is incremented (from an initialized value of, for example, zero to one) to indicate that a node in graph 400 has been accessed. Also, the node-access counter (or the current value of the node-access counter) is compared with the quantity of nodes in graph 400 to determine whether the node-access counter satisfies the condition relative to the quantity of nodes in graph 400. In this example, the condition is an equality condition.

After determining that the node-access counter does not satisfy the condition, the enhanced graph traversal (or a graph analysis module implementing the enhanced graph traversal) then identifies edge 411, and as illustrated in FIG. 4B follows (or considers) edge 411 to access node N432. Similarly, as illustrated in FIG. 4C, the enhanced graph traversal identifies edge 421, and follows edge 421 to access node N433. The node-access counter is incremented in response to accessing each of nodes N432 and N433. In the present example, the node-access counter currently has a value of three. Additionally, the node-access counter is compared with the quantity of nodes in graph 400 to determine whether the node-access counter satisfies the condition relative to the quantity of nodes in graph 400 in response to incrementing the node-access counter.

Similar to the operations illustrated in FIGS. 4B and 4C: FIG. 4D illustrates following edge 412 to access node N434, the node-access counter is incremented in response to accessing node N434, and the node-access counter is compared with the quantity of nodes in graph 400 to determine whether the node-access counter satisfies the condition relative to the quantity of nodes in graph 400; FIG. 4E illustrates following edge 413 to access node N435, the node-access counter is incremented in response to accessing node N435, and the node-access counter is compared with the quantity of nodes in graph 400 to determine whether the node-access counter satisfies the condition relative to the quantity of nodes in graph 400; FIG. 4F illustrates following edge 422 to access node N436, the node-access counter is incremented in response to accessing node N436, and the node-access counter is compared with the quantity of nodes in graph 400 to determine whether the node-access counter satisfies the condition relative to the quantity of nodes in graph 400; and FIG. 4G illustrates following edge 423 to access node N437, and the node-access counter is incremented in response to accessing node N437.

At this point in the enhanced graph traversal, the node-access counter currently has a value of seven. The node-access counter is then compared with the quantity of nodes in graph 400 to determine whether the node-access counter satisfies the condition relative to the quantity of nodes in graph 400. Because the node-access counter has a value of seven and the quantity of nodes in graph 400 has a value of seven, the condition is satisfied. Accordingly, the enhanced graph traversal aborts (or terminates) without considering edges 414, 415, 424, and 425. As illustrated in FIG. 4H, edges 414, 415, 424, and 425 which are not considered are illustrated with dotted lines.

Because all the nodes of graph 400 have been accessed when the enhanced graph traversal aborts, the result of the traversal is the same (here, all the nodes were accessed in a breadth-first order) as the result would have been had all the edges of graph been considered. More specifically, in this example, considering edges 414, 415, 424, and 425 would not change the result of the graph traversal (here, breadth-first search) because node N431 has already been accessed or found. In other words, aborting in response to determining that the node-access counter satisfies the condition relative to the quantity of nodes in graph 400 does not affect the results of the breadth-first traversal, but reduces the number of edges that are considered. Here, the number of edges considered was reduced from ten to six—a 40% reduction.

Moreover, considering an edge includes executing instructions at a processor to access memory at which a representation of that edge is stored and then executing additional instructions at the processor to access a node connected to or associated with that edge. Furthermore, typically, the processor further executes instructions to determine whether the accessed node has been previously accessed. Thus, many instructions need not be executed by avoiding unnecessary consideration of even a single edge.

In this example, the number of nodes and edges has been limited to a small number to facilitate understanding of the systems and methodologies described herein, in practical implementations, however, graphs include thousands, millions, or even billions of nodes and edges. For example, graphs that represent network environments such as corporate networks or large mesh network deployments can have thousands of nodes that represent communications entities within those network environments; graphs that represent social networks can include hundreds of millions of nodes representing the users of those social networks; and graphs that represent task hierarchies for scheduling in computing systems can includes thousands of nodes representing tasks (or processes) to be executed in those computing systems. Even modest reductions of average-case runtimes of graph traversals for such systems can provide significant performance enhancements such as enhanced processing throughput, reduced latency, and enhanced responsiveness. That is, for such practical systems, the performance enhancements are magnified because the number of instructions that need not be executed by avoiding unnecessary consideration of a single edge is multiplied by the number of edges that are not considered when a graph traversal is aborted in response to a determination that a node-access counter satisfies a condition relative to a quantity of nodes in a graph.

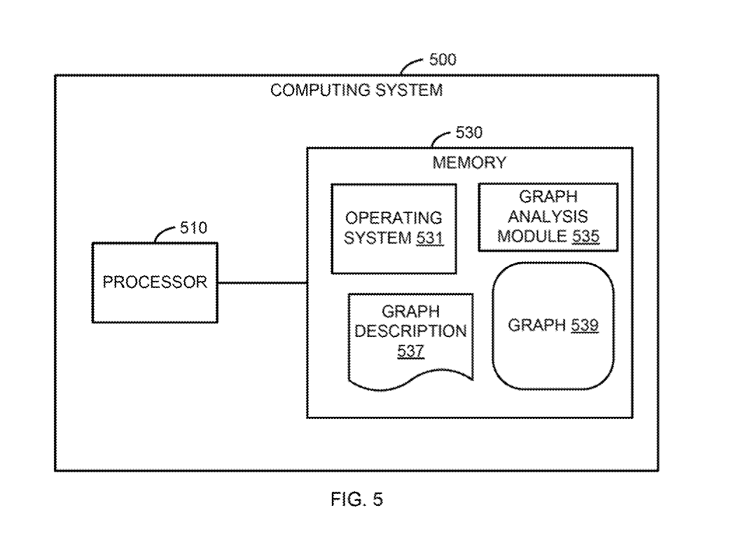

FIG. 5 is a schematic block diagram of a computing system hosting a graph and a graph traversal module, according to an implementation. In some implementations, a computing system hosting graph analysis module is itself referred to as a graph analysis module or system. In the example illustrated in FIG. 5, computing system 500 includes processor 510 and memory 530. Computing system 500 can be, for example, a personal computer such as a desktop computer or a notebook computer, a tablet device, a smartphone, a distributed computing system (e.g., a group, grid, or cluster of individual computing systems), or some other computing system.

Processor 510 is any combination of hardware and software that executes or interprets instructions, codes, or signals. For example, processor 510 can be a microprocessor, an application-specific integrated circuit (ASIC), a graphics processing unit (GPU) such as a general purpose GPU (GPGPU), a distributed processor such as a cluster or network of processors or computing systems, a multi-core or multi-processor, or a virtual or logical processor of a virtual machine.

Memory 530 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 530 can be a volatile random access memory (RAM), a persistent data store such as a hard-disk drive or a solid-state drive, a compact disc (CD), a digital versatile disc (DVD), a Secure Digital™ (SD) card, a MultiMediaCard (MMC) card, a CompactFlash™ (CF) card, or a combination thereof or of other memories. Said differently, memory 530 can represent multiple processor-readable media. In some implementations, memory 530 can be integrated with processor 510, separate from processor 510, or external to computing system 500.

Memory 530 includes instructions or codes that when executed at processor 510 implement operating system 531 and graph analysis module 535. A graph analysis module is a combination of hardware and software that analyzes graphs using one or more of the methodologies described herein.

As illustrated in FIG. 5, memory 530 is operable to store graph description 537 and graph 539. For example, during run-time of operating system 531, graph description 537 can be accessed to construct graph 539 and to identify the quantity of nodes within graph 539. As another example, computing system 500 can include (not illustrated in FIG. 5) a processor-readable medium access device (e.g., CD, DVD, SD, MMC, or a CF drive or reader), and can access graph description 537 at another processor-readable medium via that processor-readable medium access device. As yet another example, computing system 500 can include (not illustrated in FIG. 5) a communications interface such as a network interface at which a database is accessible, and can access graph description 537 at the database.

In some implementations, computing system 500 can be a virtualized computing system. For example, computing system 500 can be hosted as a virtual machine at a computing server. Moreover, in some implementations, computing system 500 can be a computing appliance or virtualized computing appliance, and operating system 531 is a minimal or just-enough operating system to support (e.g., provide services such as a communications protocol stack and access to components of computing system 500 such as a communications interface) graph analysis module 535.

Graph analysis module 535 and/or graph description 537 can be accessed or installed at computing system 500 from a variety of memories or processor-readable media. For example, computing system 500 can access graph analysis module 535 and/or graph description 537 at a remote processor-readable medium via a communications interface (not shown). As a specific example, computing system 510 can be a network-boot device that accesses operating system 531, graph analysis module 535, and graph description 537 during a boot process (or sequence).

As another example, computing system 500 can include (not illustrated in FIG. 5) a processor-readable medium access device (e.g., CD, DVD, SD, MMC, or a CF drive or reader), and can access graph analysis module 535 and/or graph description 537 at a processor-readable medium via that processor-readable medium access device. As a more specific example, the processor-readable medium access device can be a DVD drive at which a DVD including an installation package for one or more of graph analysis module 535 and graph description 537 is accessible. The installation package can be executed or interpreted at processor 510 to install one or more of graph analysis module 535 and graph description 537 at computing system 500 (e.g., at memory 530 and/or at another processor-readable medium such as a hard-disk drive). Computing system 500 can then host or execute one or more of graph analysis module 535 and graph description 537.

In some implementations, graph analysis module 535 and graph description 537 can be accessed at or installed from multiple sources, locations, or resources. For example, some components of graph analysis module 535 and graph description 537 can be installed via a communications link (e.g., from a file server accessible via a communication link and a communications interface of computing system 500), and other components of graph analysis module 535 and graph description 537 can be installed from a DVD.

In other implementations, graph analysis module 535 and graph description 537 can be distributed across multiple computing systems. That is, some components of graph analysis module 535 and graph description 537 can be hosted at one computing system and other components of graph analysis module 535 and graph description 537 can be hosted at another computing system. As a specific example, graph analysis module 535 and graph description 537 can be hosted within a cluster of computing systems where components of each of graph analysis module 535 and graph description 537 are hosted at multiple computing systems, and no single computing system hosts all the components of each of graph analysis module 535 and graph description 537.

Although a particular module or modules (i.e., combinations of hardware and software) are illustrated and discussed in relation to FIG. 5 and other example implementations, other combinations or sub-combinations of modules can be included within other implementations. Said differently, although modules illustrated in FIG. 5 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules. As a specific example, a graph analysis module can be implemented using a group of electronic and/or optical circuits (or circuitry) rather than as instructions stored at memory and executed at a processor.

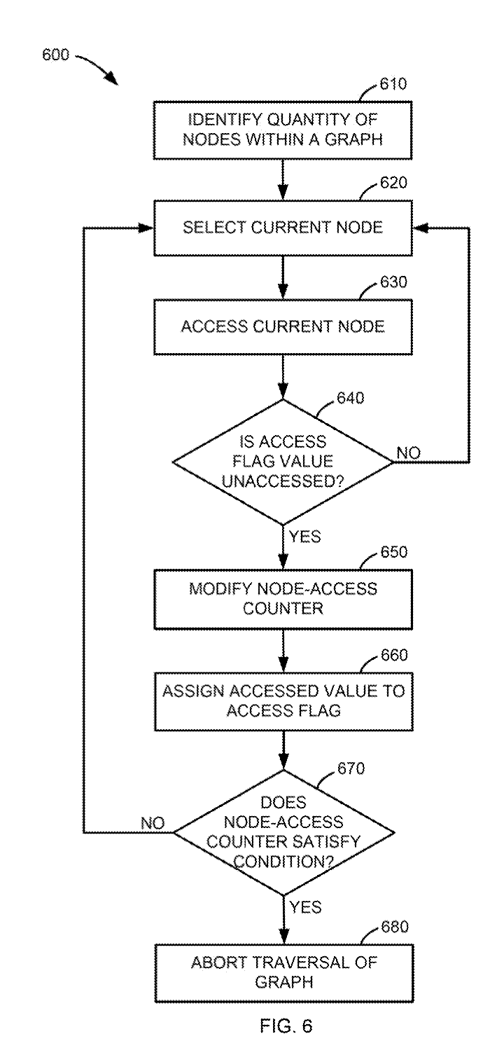

FIG. 6 is a flowchart of an enhanced graph traversal, according to another implementation. Enhanced graph traversal 600 illustrated at FIG. 6 is a particular example of an enhanced graph traversal. Other enhanced graph traversals can have additional, fewer, and/or rearranged blocks or steps than those illustrated in the example of FIG. 6.

A quantity of nodes within a graph is identified at block 610. A graph analysis module can identify the quantity of nodes within a graph using any of a variety of methodologies. For example, one or more of the methodologies discussed above in relation to block 110 of FIG. 1 can be used to identify the quantity of nodes within the graph at block 610. A current node is then selected at block 62G. The first time block 620 is performed for enhanced graph traversal 600, the current node can be referred to as the source node of the graph traversal. In some implementations, the graph has a source node, and the source node is selected the first time block 620 is performed for enhanced graph traversal 600.

The current node is then accessed at block 630, and enhanced graph traversal 600 determines at block 640 whether an access flag of the current node has an unaccessed value. The current node can be accessed, for example, by accessing a group of memory locations within a memory at which the current node is stored. The access flag is a memory location (or group of memory locations) at which a value is stored that describes whether the current node has been accessed. An accessed value at the access flag indicates that the current node has previously been accessed, and an unacessed value at the access flag indicates that the current node has not been previously accessed during enhanced graph traversal 600. In some implementations, an accessed flag indicates whether the per-node output information for the node with which that accessed flag is associated has been determined. In such implementations, an accessed value indicates that the output information for that node has been finalized, and an unaccessed value indicates that the output information for that node has not been finalized.

If the current node has an unaccessed value, the node-access counter is modified (e.g., incremented) at block 650 to indicate a unique (or distinct) access of the current node (i.e., the current node has been accessed for the first time), and an access value is assigned to the access flag at block 660. Thus, subsequent access to the access flag of the current node will indicate that the current node has been accessed.

Enhanced graph traversal 600 then determines at block 670 whether the node-access counter satisfies a predetermined condition relative to the quantity of nodes within the graph determined at block 610. If the condition is satisfied (e.g., if the node-access counter has a value equal to the quantity of nodes within the graph), traversal of the graph is aborted at block 680. Thus, as discussed above, some edges may not be considered during enhanced graph traversal 600.

If the condition is not satisfied at block 670, enhanced graph traversal 600 returns to block 620 at which another node is selected as the current node. For example, enhanced graph traversal 600 can follow edges connecting the current node to other nodes, and place the other nodes in a queue or other list. One of those other nodes can then be selected at block 620 as the current node. Also, referring to block 640, if the access flag has an accessed value, enhanced graph traversal 600 can return to block 620 to select a new current node.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements) software hosted at hardware (e.g., software that is stored at a memory and executed or interpreted at a processor), or hardware and software hosted at hardware.

Additionally, as used herein, the singular forms “a,” “an,” “the” include plural referents unless the context clearly dictates otherwise. Thus, for example, the term “module” is intended to mean one or more modules or a combination of modules. Moreover, the term “provide” as used herein includes push mechanism (e.g., sending data to a computing system or agent via a communications path or channel), pull mechanisms (e.g., delivering data to a computing system or agent in response to a request from the computing system or agent), and store mechanisms (e.g., storing data at a data store or service at which a computing system or agent can access the data). Furthermore, as used herein, the term “based on” means “based at least in part on.” Thus, a feature that is described as based on some cause, can be based only on the cause, or based on that cause and on one or more other causes.

What is claimed is:

1. A processor-readable medium storing code representing instructions that when executed at a processor cause the processor to:
identify a quantity of nodes within a graph;
traverse a portion of the graph; and
abort traversal of the graph in response to a determination that a node-access counter satisfies a condition relative to the quantity of nodes within the graph such that at least one edge of the graph is not considered during traversal of the graph.

2. The processor-readable medium of claim 1, wherein traversing the portion of the graph includes:
selecting a node from a plurality of nodes within the graph as a current node;
accessing the current node;
modifying the node-access counter for the current node;
selecting another node from the plurality of nodes as the current node; and
repeating the accessing and the modifying if the node-access counter does not satisfy the condition relative to the quantity of nodes within the graph.

3. The processor-readable medium of claim 1, wherein the condition is an equality condition.

4. The processor-readable medium of claim 1, condition is a predetermined percentage condition.

5. A processor-readable medium storing code representing instructions that when executed at a processor cause the processor to;
identify a quantity of nodes within a graph;
select a current node from the graph;
access the current node to identify a value of an access flag of the current node and, if the value of the access flag of the current node is an unaccessed value, to modify a node-access counter and to assign an accessed value to the access flag of the current node;
determine whether the node-access counter satisfies a condition relative to the quantity of nodes within the graph; and
in response to determining whether the node-access counter satisfies the condition relative to the quantity of nodes within the graph,
select another node from the graph as the current node and repeat the accessing and the determining if the node-access counter does not satisfy the condition relative to the quantity of nodes within the graph, or
abort a traversal of the graph if the node-access counter satisfies the condition relative to the quantity of nodes within the graph.

6. The processor-readable medium of claim further comprising code representing instructions that when executed at the processor cause the processor to:
access a description of the graph; and
define the graph within a memory accessible to the processor based on the description of the graph, the quantity of nodes within the graph is identified based on the description of the graph.

7. The processor-readable medium of claim 5, further comprising code representing instructions that when executed at the processor cause the processor to:
receive a plurality of requests to add nodes to the graph;
define, in response to each request from the plurality of requests, a node within a memory accessible to the processor;
insert the node defined in response to each request from the plurality of requests into the graph, the quantity of nodes within the graph is identified by updating the quantity of nodes in response to each request from the plurality of requests.

8. The processor-readable medium of claim 5, wherein:
each node from a plurality of nodes in the graph represents a communications entity; and
the traversal is a connectivity traversal.

9. The processor-readable medium of claim 5, wherein each node from a plurality of nodes in the graph represents a user of a social network environment.

10. The processor-readable medium of claim 5, wherein each node from a plurality of nodes in the graph represents a gene, and edges connecting nodes from the plurality of nodes represent partial order information of the genes within a chromosome.

11. The processor-readable medium of claim 5, wherein the traversal identifies a path between a pair of waypoints.

12. The processor-readable medium of claim 5, wherein the traversal performs a flow analysis on a software application.

13. The processor-readable medium of claim 5, wherein the condition is an equality condition.

14. The processor-readable medium of claim 5, wherein the condition is a predetermined percentage condition.

15. A graph traversal method, comprising:
identifying a quantity of nodes within a graph stored at a memory;
selecting a node from a plurality of nodes within the graph as a current node; and
traversing the graph,
the traversing includes accessing the current node at a portion of the memory associated with the current node, modifying a node-access counter in response to accessing the current node, selecting another node from the plurality of nodes as the current node and repeating the accessing and the modifying if the node-access counter does not satisfy a condition relative to the quantity of nodes within the graph, and
aborting the traversing if the node-access counter satisfies the condition relative to the quantity of nodes within the graph.

16. The processor-readable medium of claim 15, wherein:
each node from the plurality of nodes in the graph represents a communications entity; and
the traversing is a connectivity traversal.

17. The processor-readable medium of claim 15, wherein each node from the plurality of nodes in the graph represents a user of a social network environment.

18. The processor-readable medium of claim 15, wherein each node from a plurality of nodes in the graph represents a gene, and edges connecting nodes from the plurality of nodes represent partial order information of the genes within a chromosome.

19. The processor-readable medium of claim 15, wherein the condition an equality condition.

20. The processor-readable medium of claim 15, wherein the condition is a predetermined percentage condition.
